(19) United States
(12) Patent Application Publication
(10) Pub. No.: US 2006/0011528 A1
(43) Pub. Date: Jan. 19, 2006

(54) Animal water tub

(76) Inventor: Jonathan Ireland, West Chester, PA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 11/224,257

(22) Filed: Sep. 12, 2005

Related U.S. Application Data
(60) Provisional application No. 60/609,297, filed on Sep. 13, 2004.

(51) Int. Cl. B01D 35/00; A01K 7/00

(52) U.S. Cl. 210/167; 119/72; 210/184

(57) ABSTRACT

An animal water tank has a recirculating pump unit positioned in a water tub container. The unit has a filter for removing contaminants from the recirculating water. The unit also has a heater so that water recirculates through the heater. A water level indicator and a solar panel are on the unit.

### FIELD OF THE INVENTION

This invention relates to a livestock watering tank such as a horse water tub.

### BACKGROUND OF THE INVENTION

Typically, horses are turned out in pastures. Water is essential for all mammals to live. Horses living outside usually have a large tub container filled with water to supply this need. The most widely used today is the 100 gallon tub made by Rubbermaid. The invention fits this model and can be adapted to other containers. Problems with tub type water containers used today are described below.

A horse eats from the ground and picks up rocks, dirt, grass, and small insects and parasites all of which can make a horse sick or die. Another problem is that water freezes when the temperature drops below 32° F. Electric heating elements are currently available but they require an electric source nearby. The units are extremely inefficient in extreme cold. The reason is that the heating element is at the bottom of the tub and doesn't heat the whole tub. Another problem with most water tubs is that they are far from the barn or house, making the water level of the tub a guessing game.

It is an object of the present invention to obviate the foregoing and other problems of animal watering tubs.

### SUMMARY OF THE INVENTION

In accordance with the present invention, an animal watering tub has a unit with a re-circulating pump and a filter. The circulating filtration system automatically cleans the water and the collected particles and debris can be dumped. A heater heats the circulating water. The invention will not only heat the water but it will periodically re-circulate all the water in the tub, keeping the water temperature more constant and providing more efficient heating.

The invention will raise a plastic flag, much like on the side of a mailbox, to indicate the need to refill the tub.

The invention can be conventionally powered or solar powered. The solar panel fits on the rim of the tub to get the maximum sunlight. With solar power, electric bills go down and running wiring to far away pastures is no longer necessary.

The invention keeps animals' water cleaner, healthier, moving and warmer in the winter.

The foregoing and other objects, features and advantages of the invention will be better understood from the following more detailed description and dependent claims.

### BRIEF DESCRIPTION OF THE DRAWINGS

FIG. 1 shows the livestock water tank;

FIG. 1A is a section on the line A-A of FIG. 1 and shows the tub with a unit having the recirculating pump, filter and heater of the present invention installed;

FIG. 2 shows a process flow diagram of the unit of the present invention; and

FIG. 3 shows an alternative embodiment with the unit in the tub.

### DETAILED DESCRIPTION OF ILLUSTRATIVE EMBODIMENTS

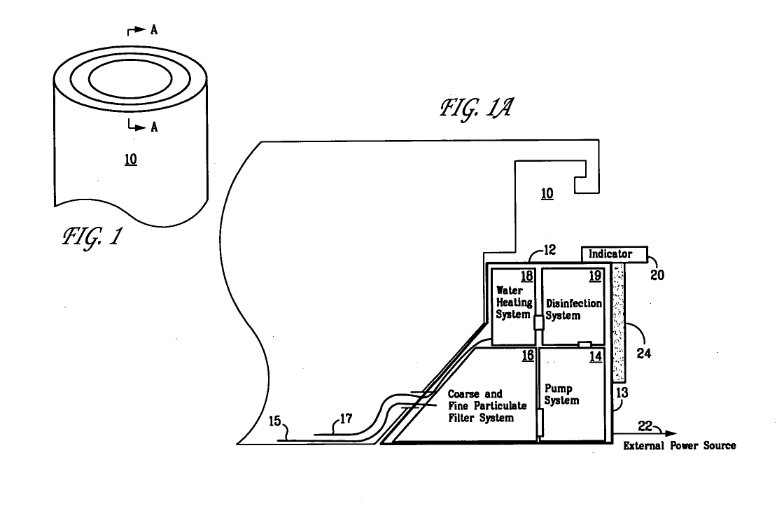

As shown in FIGS. 1 and 1A a livestock water tank includes a tub 10 positioned adjacent a unit 12. In the exemplary embodiment, tub 10 is a Rubbermaid 100 gallon tub. Unit 12 has a pump 14, a filter 16, a heater 18, a disinfectant system 19 and an indicator 20. Pump 14 has an influent line 15 which draws water from the bottom of the tub. The water flows through filter 16 and heater 18. Warm water from heater 18 is returned to the tub through effluent line 17. It rises towards the top of the tub. Water is drawn downwardly by the pump 14. This creates a recirculation flow pattern. Unit 12 has a solid outer covering 13 enclosing the components.

In an exemplary embodiment, pump 14 and filter 16 are a commercially available pond pump filter with a biological filter. Periodically, the filter 16 must be cleaned or replaced. Disinfection system 19 controls bacteria growth. A level sensor activates indicator 20 when the level of water in the tub falls below the desired level.

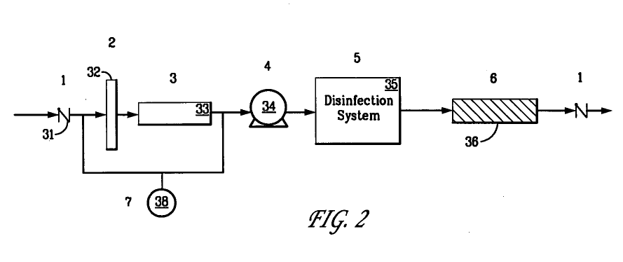

FIG. 2 shows a process flow diagram of the agricultural water filter system. Check valve 31 insures proper flow direction. Coarse particulate filter 32 removes large particulate material and fine particulate filter 33 removes fine debris. Pump 34 is capable of turning over the water level of the tub at least once per hour. Disinfection system 35 provides bacterial disinfection of the water. Heating coil 36 has an on/off switch for cold weather use. Check valve 37 at the effluent line insures proper water flow.

Pressure level indicator 38 senses pressure across the filter. A light on this indicator indicates that attention is required when the pressure differential is not correct.

As shown in FIG. 1A, a plug 22 provides a connection to a conventional electrical outlet. Alternatively, a solar panel 24 is positioned on the unit 12 to provide solar power to the unit.

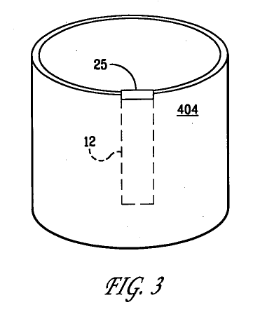

In the alternative of FIG. 3 the unit 12 has a clip 25 for holding it in the tub. Alternatively, the tub has molded tabs which hold the unit in the tub.

Other modifications will be apparent to those skilled in the art. The appended claims therefore cover all such modifications and applications which are within the true spirit and scope of the invention.

What is claimed:

1. An animal water tank comprising:
a tub container for holding water; and
a water recirculation pump for recirculating said water in said container.

2. The water tank recited in claim 1 further comprising a filter, said pump recirculating water through said filter to remove contaminants therefrom.

3. The livestock water tank recited in claim 1 and a heater, said recirculating pump causing water to recirculate past said heater.

4. The livestock water tank recited in claim 1 and an indicator to visibly indicate the level water in said tub.

5. The livestock water tank recited in claim 3 wherein said pump and heater are powered by a conventional electric supply.

6. The livestock water tank recited in claim 1 further comprising:
a solar panel for supplying power to said recirculating pump.

7. The livestock watering tank recited in claim 1 wherein said recirculating pump is contained in a unit, said unit having a clip which holds said unit in said tub.

8. The livestock watering tank recited in claim 1 wherein said tub is a molded plastic tub having molded therein positioning tabs which hold said recirculating pump.

9. A recirculating pump unit for a livestock watering tank comprising:
a recirculating pump and means for connecting said unit to a tub to recirculate water therein.

10. The unit recited in claim 9 further comprising:
a filter, said pump being connected to said filter to recirculate water through said filter.

11. The unit recited in claim 9 and
a water heater, said unit recirculating water past said heater in said water tank.

12. The unit recited in claim 9 further comprising:
an indicator for indicating the level of water in said tank.

13. The unit recited in claim 9 further comprising:
a solar panel for powering said pump.

14. The unit recited in claim 9 wherein said livestock watering tank has a tub with positioning means, said unit fitting into said positioning means.
